(19) United States
(12) Patent Application Publication
(10) Pub. No.: US 2019/0291353 A1
(43) Pub. Date: Sep. 26, 2019

(54) HEATING DEVICE AND HEATING METHOD

(71) Applicant: CHUO HATSUJO KABUSHIKI KAISHA, Aichi (JP)

(72) Inventor: Toru Ito, Aichi (JP)

(21) Appl. No.: 16/341,471

(22) PCT Filed: Nov. 8, 2017
(86) PCT No.: PCT/JP2017/040297

§ 371 Date: Apr. 12, 2019

(30) Foreign Application Priority Data
Nov. 11, 2016 (JP) 2016-220659

(51) Int. Cl. B29C 65/36; H05B 6/36; B29C 65/00

(52) U.S. Cl. CPC B29C 65/3656; H05B 6/362; B29L 2009/003; B29C 66/72321; B29C 66/742; H05B 6/365

(57) ABSTRACT

This heating device is to be used when joining a rubber member onto the surface of a metal member by heating. This heating device has a coil portion and an iron core portion. The coil portion is configured in such a manner as to induce a magnetic field. The iron core portion is arranged in such a manner as to extend from a first region to a second region of the metal member so as to straddle over the rubber member, and passes through the coil portion.

### CROSS REFERENCE TO RELATED APPLICATIONS

This international application claims priority to Japanese Patent Application No. 2016-220659, filed with the Japanese Patent Office on Nov. 11, 2016, which is incorporated herein by reference in its entirety.

### TECHNICAL FIELD

The present disclosure relates to a heating device, used when making a rubber member heat-joined (heat-bonded) to a surface of a metal member.

### BACKGROUND ART

For example, in a joining method described in Patent Reference 1, (a) after an adhesive is applied to a metal member such as a stabilizer, (b) in the state where a rubber bushing is crimped at a portion where the adhesive is applied, and (c) a coil disposed on two sides spaced by the rubber bushing, are energized (electrified), so as to heat the stabilizer.

### Prior Art Reference

### Patent Reference

Patent Reference 1: Japanese Patent Publication No. 2006-290313.

### SUMMARY

### Problems to be Solved by the Disclosure

In the invention described in Patent Reference 1, portions of the stabilizer where a coil is disposed, i.e., two sides of the stabilizer that are spaced by the rubber bushing generate heat, and the heat generated from the portions is transmitted to a crimping portion between the stabilizer and the rubber bushing via the stabilizer. Therefore, the time required to heat the crimping portion to a joining temperature is likely to become longer. Therefore, the heating time and the power consumption during heating may increase.

Further, the induction heating is performed by utilizing the Joule heat loss of the current (induced current) generated by the induction in the metal member, thereby mainly generating heat on the surface of the metal member (for example, a depth range of about 0.2 mm from the surface). Therefore, in the method of disposing the coil at two sides of the rubber member to generate heat from the metal member, it is difficult to efficiently conduct heat to a contact position of the metal member and the rubber member.

It is preferable that one aspect of the present disclosure provides a heating device capable of efficiently heating a portion at the contact position between a metal member and a rubber member.

### Means for Solving the Problems

One embodiment of the present disclosure is directed to a heating device, used when making a rubber member heat-joined to a surface of a metal member. The heating device has a coil portion and an iron core portion. The coil portion is configured to induce a magnetic field. The iron core portion is disposed in such a manner as to straddle over the rubber member from a first region to a second region of the metal member, and penetrates through the coil portion.

Therefore, a portion of the metal member located between the first region and the second region cooperates with the iron core portion, to constitute a magnetic path through which the magnetic flux induced by energization of the iron coil portion passes. Therefore, an induced current is also generated at a portion (hereinafter referred to as a contact portion) of the surface of the metal member that is brought into contact with the rubber member.

That is, in the present disclosure, the contact portion is not heated by heat conduction, but the contact portion is directly heated by generating heat. Therefore, the portion where the metal member is in contact with the rubber member can be efficiently heated.

Further, the “iron core portion” of the present disclosure may be made of a material with good magnetization characteristics. Therefore, it is of course possible to be made of an iron material and the iron core portion may be made of a material other than iron as long as it is a material with good magnetization characteristics.

### BRIEF DESCRIPTION OF DRAWINGS

FIG. 1 is a conceptual diagram of a heating device of a first embodiment.

FIG. 2 is a conceptual diagram of a heating device of a first embodiment.

FIGS. 3A and 3B are conceptual diagrams of a heating device of a second embodiment.

FIG. 4 is a diagram showing characteristics of a heating device of a third embodiment.

### DESCRIPTION OF REFERENCE NUMERALS

1. heating device, 3. coil portion, 5. iron core portion, 5A. first iron core portion, 5B, 5C. second iron core portion, 5D. interposing body, 7. power supply for energization, W1. stabilizer, W2. rubber bushing.

### DETAILED DESCRIPTION OF EMBODIMENTS

The “embodiment of the invention” described below shows one example of an embodiment falling within the technical scope of the present disclosure. In other words, the inventive specific matters and the like described in the claims are not limited to the specific configurations, structures, or the like described in the following embodiments.

Hereinafter, embodiments of the present disclosure will be described with reference to the drawings. In addition, an arrow or the like indicating a direction in each drawing is recited in order to facilitate understanding of the relationship between the drawings. The arrows or the like (directions) in the respective drawings do not limit the scope of the present disclosure.

The number of the member or part at least described with a reference numeral denoted will be at least one, except for the case where the term “one” or the like is described in advance. In other words, the number of the members provided may be two or more in the case where the term “one” or the like is not described in advance.

### First Embodiment

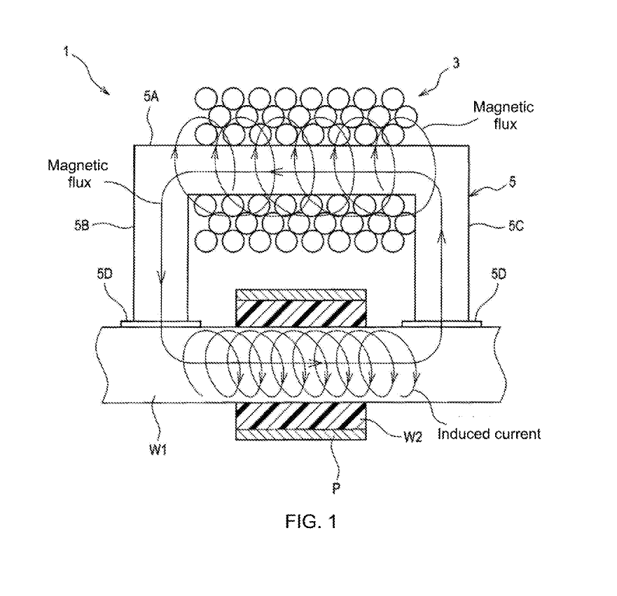

The present embodiment describes a heating device and a heating method for making a rubber bushing heat-joined to a stabilizer of a vehicle. The stabilizer W1 shown in FIG. 1 is an example of a metal member, and is a torsion bar-shaped member made of metal for suppressing the roll (inclination) of the vehicle body.

The rubber bushing W2 shown in FIG. 1 is an example of a rubber member, and is a substantially cylindrical member made of rubber. Further, a cylindrical element P made of metal is joined to an outer circumferential surface of the rubber bushing W2 of the present embodiment. The cylindrical element P is joined by a heat joining method such as vulcanization joining, before the rubber bushing W2 is joined by heating to the stabilizer W1.

### 1. Structure of the Heating Device

As shown in FIG. 1, the heating device 1 has at least a coil portion 3 and an iron core portion 5. The coil portion 3 is formed by winding an electric conducting wire into a coil shape, and is used for inducing a magnetic field when energized.

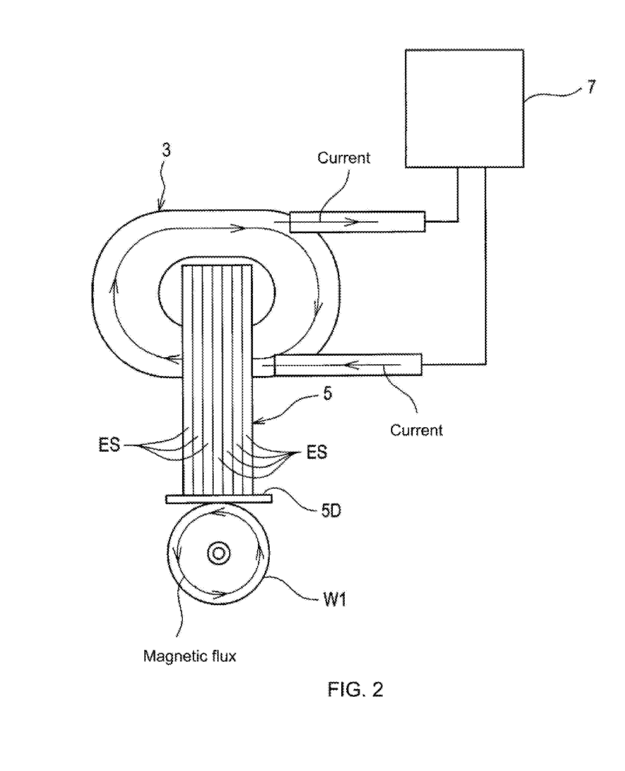

As shown in FIG. 2, the coil portion 3 is supplied (energized) with an alternating current at a predetermined frequency from a power supply 7 for energization. The power supply 7 for energization of the present embodiment is an inverter type power supply, and energizes the coil portion 3 when it is converted into a frequency of a commercial power supply. Further, the above frequency is, for example, 60 Hz to 300 Hz or 60 Hz to 400 Hz.

As shown in FIG. 1, the iron core portion 5, which is a member made of an iron-based metal, is disposed in such a manner as to straddle over the rubber bushing W2 from a first region to a second region of the stabilizer W1, and has a part penetrating through the coil portion 3.

Specifically, the iron core portion 5 has a first iron core portion 5A and a pair of second iron core portions 5B and 5C, forming a substantially C shape or a substantially U shape. The first iron core portion 5A is an iron core that penetrates through the inside of the coil portion 3. The pair of second iron core portions 5B and 5C extend from two ends of the first iron core portion 5A in the extending direction thereof toward the stabilizer W1 side (the side where the stabilizer is located), respectively.

As shown in FIG. 2, the iron core portion 5 of the present embodiment is formed in a way that a plurality of electromagnetic steel sheets ES are laminated with electrical insulators (not shown) in between. Furthermore, the lamination direction of the plurality of electromagnetic steel sheets ES is a direction substantially perpendicular to the extending direction of the first iron core portion 5A.

In other words, a plurality of electromagnetic steel sheets ES are laminated in a direction substantially perpendicular to the “direction of a magnetic field” generated inside the coil portion 3, that is, in a direction parallel to the sheet thickness direction of the respective electromagnetic steel sheets ES. In addition, in FIG. 2, the lamination direction is substantially parallel to the left-right direction of a paper surface.

In the present embodiment, a plurality of electromagnetic steel sheets ES which are formed into a substantially C shape or a substantially U shape are laminated in the sheet thickness direction, to constitute the iron core portion 5. End faces of the iron core portion 5, that is, portions facing the stabilizer W1, i.e., end faces of the pair of second iron core portions 5B and 5C, are brought into direct or indirect contact with the stabilizer W1.

Further, in the present embodiment, each of the end faces of the second iron core portions 5B and 5C is brought into indirect contact with the stabilizer W1, with an interposing body 5D made of an insulator in between. This interposing body 5D is a member for preventing the stabilizer W1 and the iron core portion 5 from rubbing each other to damage a surface coating film of the stabilizer W1.

### 2. Characteristics of the Heating Device of the Present Embodiment

The present embodiment has: a coil portion 3, for inducing a magnetic field; and an iron core portion 5, being disposed in such a manner as to straddle over the rubber bushing W2 from a first region to a second region of the stabilizer W1, and penetrating through the coil portion 3.

Thus, a portion of the stabilizer W1 located between the second iron core portion 5B and the second iron core portion 5C, that is, a part of the stabilizer W1 that penetrates through the rubber bushing W2, cooperates with the iron core portion 5, constituting a magnetic path through which the magnetic flux induced by energization of the iron coil portion 3 passes.

Therefore, a large amount of induced current is also generated at a contact portion of the surface of the stabilizer W1 which is brought into contact with the rubber bushing W2. That is, in the present embodiment, the contact portion is not indirectly heated by heat conduction, but the contact portion is directly heated by generating heat. Therefore, the portion where the stabilizer W1 is in contact with the rubber bushing W2 can be efficiently heated.

The iron core portion 5 is formed in a way that a plurality of electromagnetic steel sheets ES are laminated with electrical insulators in between, and the lamination direction of the plurality of electromagnetic steel sheets ES is a direction perpendicular to a direction from the first region toward the second region. Therefore, it is possible to suppress generation of unnecessary eddy currents or the like in the iron core portion 5. Therefore, the contact portion can be efficiently heated.

### Second Embodiment

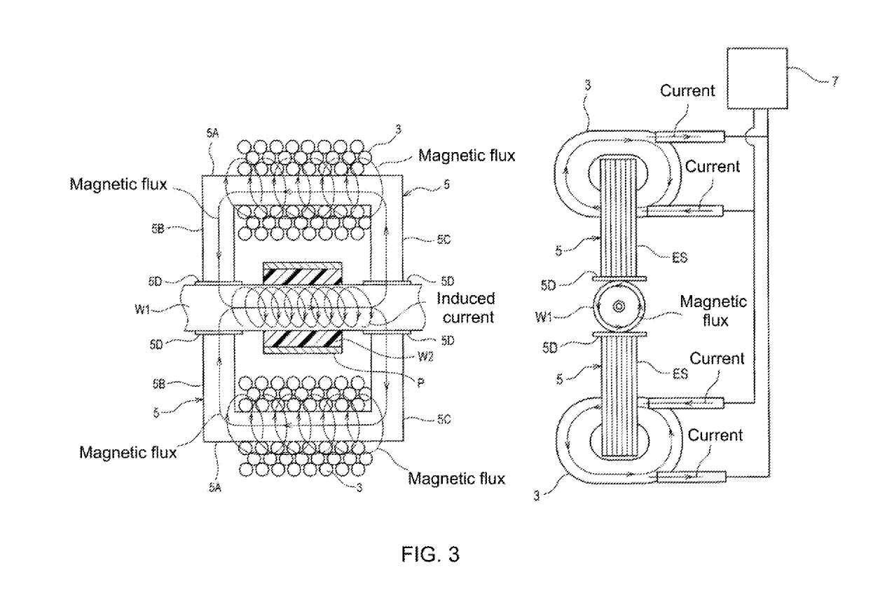

As shown in FIG. 3A and FIG. 3B, in the present embodiment, the coil portion 3 and the iron core portion 5 are configured as one set, and a plurality of sets of the coil portions 3 and the iron core portions 5 are disposed along an outer circumferential surface of the stabilizer W1. In addition, the same constituent elements or the like as those of the above-described embodiment are denoted by the same reference numerals as those of the above-described embodiment, and thus a repetitive description will be omitted.

Thus, the contact portion of the surface of the stabilizer W1 that is brought into contact with the rubber bushing W2 can be uniformly heated, the heating time can be shortened, and the amount of consumption of electric power by the heating device 1 can be reduced.

Furthermore, in the present embodiment, since the current is distributed to a plurality of coil portions 3, rise in temperature of each coil portion 3 can be suppressed.

### Third Embodiment

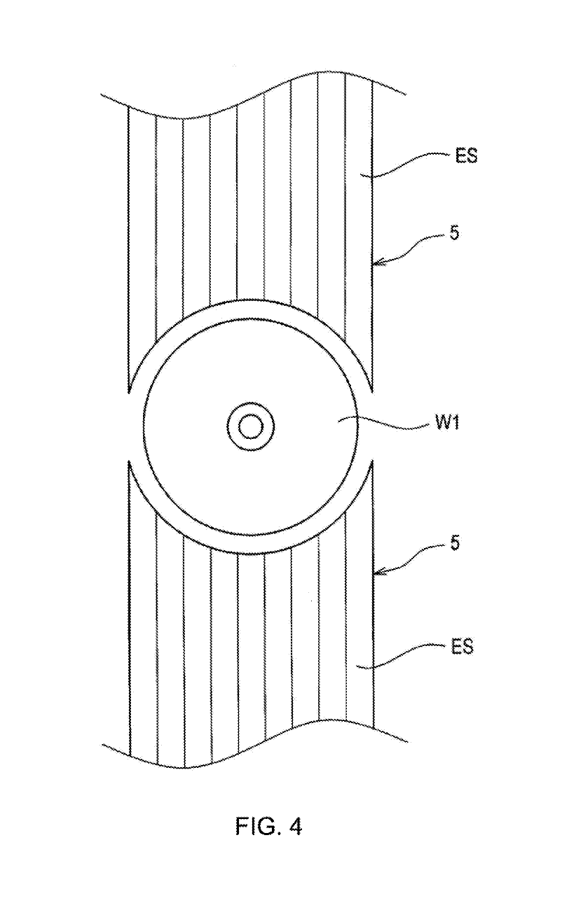

As shown in FIG. 4, in the present embodiment, the end faces of the iron core portion 5, that is, the end faces of the second iron core portions 5B, 5C, are formed by faces substantially parallel to the surface of the stabilizer W1. Further, in FIG. 4, the interposing body 5D is omitted.

Thus, it is possible to suppress an increase in the magnetic resistance of the gap or the portion at contact position between the iron core portion 5 and the stabilizer W1. Then, the magnetic flux density at the contact portion can be increased, therefore the portion at the contact position between the stabilizer W1 and the rubber bushing W2 can be efficiently heated.

The same constituent elements or the like as those of the above-described embodiment are denoted by the same reference numerals as those of the above-described embodiment, and thus a repetitive description will be omitted. Further, the present embodiment can of course be applied to the first embodiment as well.

In addition, the “end faces of the second iron core portions 5B, 5C are formed by faces substantially parallel to the surface of the stabilizer W1” refers to, for example, the following cases.

(a) The surface of the stabilizer W1 is a cylindrical surface, and the end faces of the second iron core portions 5B, 5C form a partial shape (circular arc) or an entire circumferential shape of a circle, substantially similar to the pattern outlined by the cylindrical surface.

(b) The surface of the stabilizer W1 is a square tube surface, and the end faces of the second iron core portions 5B, 5C form a partial shape or an entire circumferential shape of a rectangle, substantially similar to the pattern outlined by the square tube surface.

Further, since the second iron core portions 5B, 5C are formed by laminating the electromagnetic steel sheets ES, it is difficult to make the end faces in a smooth arc shape when the surface of the stabilizer W1 is a cylindrical surface.

Therefore, the end faces are formed in a shape that changes stepwise. Further, in the present disclosure, the case where the end faces have a stepped shape or the like is also regarded as “the end faces of the second iron core portions 5B, 5C are formed by faces substantially parallel to the surface of the stabilizer W1”.

### Other Embodiments

In the above embodiment, the end faces of the second iron core portions 5B and 5C are brought into indirect contact with the stabilizer W1, with an interposing body 5D made of an insulator in between. However, the present disclosure is not limited thereto.

That is, for example, when there is no surface coating film on the stabilizer W1, or when the surface coating film has a sufficient strength, the end faces of the second iron core portions 5B, 5C may be brought into direct contact with the stabilizer W1 without the interposing body 5D in between.

The iron core portion 5 of the above embodiment is in a structure formed by laminating a plurality of electromagnetic steel sheets ES in a direction perpendicular to the “direction of a magnetic field” generated inside the coil portion 3. However, the present disclosure is not limited thereto. That is, the iron core portion 5 may be formed from a solid member made of a material with good magnetization characteristics, for example, low-carbon steel such as S10C or the like.

In the above embodiment, the coil portion 3 is energized with an alternating current at a low frequency of about 60 Hz to 300 Hz or about 60 Hz to 400 Hz. However, the present disclosure is not limited thereto. In other words, for example, the energization frequency is a value appropriately selected depending on the material, size, and the like of an object to be heated or the like.

A heating device used for making a rubber bushing heat joined to a stabilizer of an vehicle is described in the above embodiment. However, the present disclosure is not limited thereto.

That is, the present disclosure can also be applied to joining of other metal members and rubber members. Further, the heat joining may be performed when an adhesive is applied to a joining surface of the metal member and the rubber member, or the heat joining may be performed without applying an adhesive to the joining surface.

As described above, the above stabilizer W1 is an example of a metal member. Therefore, the stabilizer W1 which is one example of the metal member is of course not limited to the torsion bar shape. Similarly, the “bar” refers to a rod-shaped member and is not only represented as a solid material, hence the “bar” also includes a hollow material.

In the above embodiment, the cylindrical element P is joined by a heat joining method such as vulcanization joining or the like, before the rubber bushing W2 is joined by heating to the stabilizer W1. However, the present disclosure is not limited thereto. That is, the cylindrical element P may be joined after the rubber bushing W2 is joined by heating to the stabilizer W1.

The present disclosure is not limited to the above embodiments as long as it meets the gist of the invention described in the claims. Therefore, at least two of the above-described plurality of embodiments can be combined.

1. A heating device, configured to be used for making a rubber member heat-joined to a surface of a metal member, the heating device comprising:
a coil portion configured to induce a magnetic field; and
an iron core portion, disposed in such a manner as to straddle over the rubber member from a first region to a second region of the metal member, and penetrating through the coil portion.

2. The heating device of claim 1,
wherein the iron core portion is formed in a way that a plurality of electromagnetic steel sheets are laminated with electrical insulators in between, and
a lamination direction of the plurality of electromagnetic steel sheets is a direction perpendicular to a direction from the first region toward the second region.

3. The heating device of claim 2,
wherein an end face of the iron core portion, which is a portion facing the metal member, is formed by a face parallel to the surface of the metal member.

4. A heating method, used for making a rubber member heat-joined to a surface of a metal member, comprising:
using a heating device comprising at least a coil portion and an iron core portion, and supplying the coil portion with a current at a predetermined frequency,
wherein the coil portion is configured to induce a magnetic field, and
the iron core portion is disposed in such a manner as to straddle over the rubber member from a first region to a second region of the metal member, and penetrates through the coil portion.
